(19) United States
(12) Patent Application Publication
(10) Pub. No.: US 2006/0187309 A1
(43) Pub. Date: Aug. 24, 2006

(54) Data communications system, image capturing apparatus and reproducing apparatus

(75) Inventors: Shinichi Ban, Sakai-shi (JP); Tougo Teramoto, Wakayama-shi (JP); Katsuyuki Nanba, Sakai-shi (JP); Toshihiro Hamamura, Yokohama-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/146,321

(22) Filed: Jun. 6, 2005

(30) Foreign Application Priority Data
Feb. 3, 2005 (JP) JP2005-027446

(51) Int. Cl. H04N 5/232

(52) U.S. Cl. 348/211.2

(57) ABSTRACT

A radio frequency IC tag is attached to an image capturing apparatus. The radio frequency IC tag stores access information for permitting access to the image capturing apparatus through a network. In this state, a reproducing apparatus (e.g., a digital TV or a printer) transmits a predetermined command to the image capturing apparatus based on the access information received from the radio frequency IC tag. In response to the predetermined command, the image capturing apparatus transmits image data to the reproducing apparatus. The reproducing apparatus then receives the image data from the image capturing apparatus, and visibly outputs the image data.

This application is based on application No. 2005-027446 filed in Japan, the contents of which are hereby incorporated by reference.

### BACKGROUND OF THE INVENTION

1. Field of the Invention

The present invention relates to data communications.

2. Description of the Background Art

Recently, digital cameras have become more widespread in the home market, and a radio frequency identification (RFID) tag has been proceeding toward practical application for control of product distribution or the like. A technique of utilizing such RFID tag and a digital camera in combination is also under consideration.

For instance, a technique of attaching an RFID tag to a subject, collecting information related to the subject through the RFID tag when capturing an image of the subject with a digital camera, adding the related information to image data, and storing the image data is proposed (e.g., Japanese Patent Application Laid-Open No. 2003-174578).

As described above, with developments in data communications between digital cameras and other equipment, digital cameras can be expanded in functionality.

In recent years, digital household appliances such as a big-screen, high-resolution digital TV have become popular, and a growing number of houses each have a network which connects a computer to another or peripheral equipment such that data communications can be made therebetween. At present, such a network only connects a personal computer and its peripheral equipment, however, a technique of connecting household appliances to one another through a network is also under development toward commercialization.

Under these circumstances, a case is considered in which a digital camera is connected to a network which connects digital electronic appliances such that data communications can be made therebetween, and a captured image acquired by the digital camera is reproduced by a reproducing apparatus such as a digital TV.

However, adequate security of information management is not ensured where a digital camera and a reproducing apparatus are easily connectable through a network. On the other hand, to ensure security, a complicated operation is required such as inputting a password or ID number each time a user connects a digital camera and reproducing apparatus through a network. That is, a problem arises in that, giving higher priority to security requires a complicated operation, and conversely, simplification of operation results in ignorance of security.

### SUMMARY OF THE INVENTION

The present invention is directed to a data communications system.

According to the invention, the data communications system comprises an image capturing apparatus and a reproducing apparatus. The image capturing apparatus includes: a radio frequency device storing access information for permitting the reproducing apparatus to make access to the image capturing apparatus; and an image data transmitter for transmitting image data to the reproducing apparatus having made access to the image capturing apparatus. The reproducing apparatus includes: a receiver for receiving the access information from the radio frequency device; an access controller for making access to the image capturing apparatus based on the access information received by the receiver; and a reproducer for reproducing image data transmitted from the image data transmitter.

For instance, in the case of employing a radio frequency device that can make data communications in a relatively short distance, a captured image acquired by the image capturing apparatus can be reproduced by the reproducing apparatus only by making the image capturing apparatus close to the reproducing apparatus; besides, the captured image can be reproduced only by a reproducing apparatus located physically close to the image capturing apparatus. Therefore, it is possible to easily connect the image capturing apparatus and reproducing apparatus through a network while ensuring security.

The invention is also directed to an image capturing apparatus and a reproducing apparatus.

It is therefore an object of the invention to provide a technique capable of easily connecting an image capturing apparatus and a reproducing apparatus through a network while ensuring security.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram illustrating an image capturing apparatus according to a preferred embodiment of the present invention;

FIG. 2 generally illustrates a radio frequency IC tag;

FIG. 3 illustrates tag information stored in the radio frequency IC tag;

FIG. 4 illustrates signal transmissions between the radio frequency IC tag and an IC tag reader;

FIG. 5 generally illustrates a data communications system according to the preferred embodiment of the invention;

FIG. 6 is a functional block diagram illustrating the data communications system;

FIG. 7 is a flow chart showing the operation of the image capturing apparatus when reproducing a captured image in a DTV;

FIGS. 8 and 9 are flow charts showing the operation of the DTV when reproducing the captured image in the DTV;

FIG. 10 illustrates data communications between the image capturing apparatus and DTV;

FIG. 11 is a flow chart showing the operation of the image capturing apparatus when reproducing a captured image in a printer; and

FIGS. 12 and 13 are flow charts showing the operation of the printer when reproducing the captured image in the printer.

### DESCRIPTION OF THE PREFERRED EMBODIMENTS

A preferred embodiment of the present invention will be described in reference to the accompanied drawings.

Image Capturing Apparatus

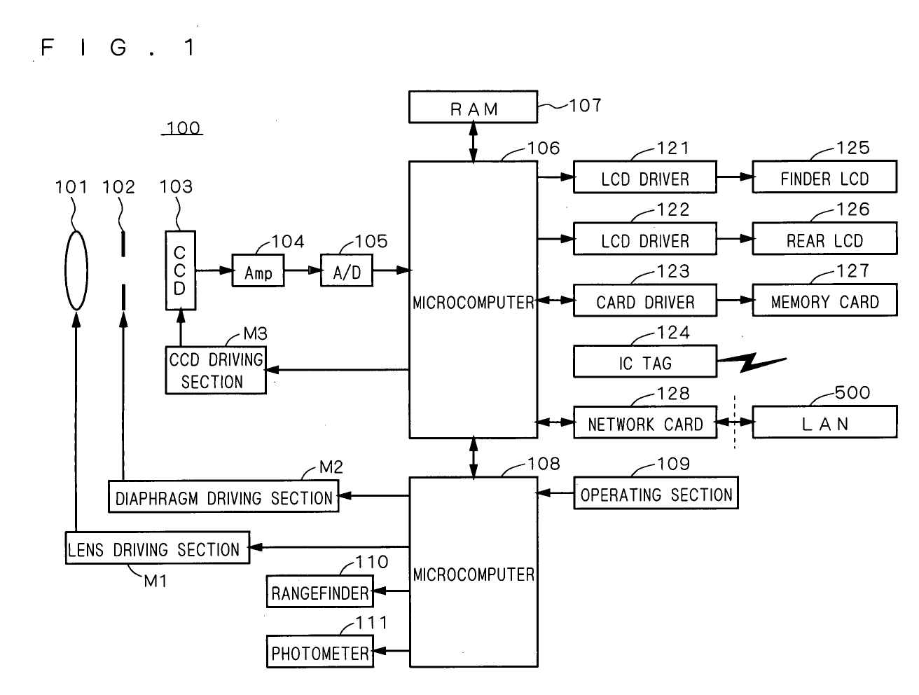

FIG. 1 is a functional block diagram illustrating an image capturing apparatus 100 according to a preferred embodiment of the present invention. The image capturing apparatus 100 is configured to serve as a digital camera (DSC).

The image capturing apparatus 100 has a recording mode (REC mode) for capturing an image and a playback mode (PLAY mode) for reproducing a captured image recorded on a memory card 127, on a rear LCD 126 or the like.

The image capturing apparatus 100 includes an operating section 109 with a shutter-release button (shutter button), various other buttons, various switches and the like. A user can switch between the REC mode and the PLAY mode by appropriately operating the operating section 109.

A taking lens device 101 can be driven back and forth along an optical path by means of a lens driving section M1 to achieve zoom adjustment or auto-focus control. Incident light passing through the taking lens device 101 forms an image on a light-receiving surface of a CCD 103 through a diaphragm 102 whose aperture being varied by a diaphragm driving section M2.

The CCD 103 is configured to serve as an area image-capturing sensor having a pixel arrangement in which, for example, transmission filters of primary-colors of R (red), G (green) and B (blue) are arranged in a lattice pattern, and photoelectrically converts light reflected from a subject to obtain analog image signals of R, G and B.

The analog image signals obtained by the CCD 103 are amplified in an amplifier 104 and the like, and are converted to digital image data in an A/D converter 105.

A microcomputer 106 is configured to include CPU, ROM and the like, for controlling the operations of respective components of the image capturing apparatus 100. The CPU reads programs stored in the ROM or the like, so that various types of control and functions are achieved.

For instance, the microcomputer 106 is capable of controlling the driving of the CCD 103 through a CCD driving section M3. Further, the microcomputer 106 is capable of storing digital image data (hereinafter abbreviated to “image data”) received from the A/D converter 105 in a RAM 107 and performing various types of processing on the image data.

A microcomputer 108 is configured to include a CPU, a ROM and the like, and transmits a signal to the microcomputer 106 in response to a signal transmitted from the operating section 109, a rangefinder 110, or a photometer 111, thereby performing various operations. For instance, switching between the REC mode and PLAY mode is made by the microcomputers 106 and 108 in response to a user's operation of the operating section 109.

Further, in accordance with the distance from the subject measured by the rangefinder 110, the microcomputers 106 and 108 drive the taking lens device 101 through the lens driving section M1, thereby achieving auto-focus.

Furthermore, in accordance with the luminance of the subject measured by the photometer 111, the microcomputers 106 and 108 drive the diaphragm 102 through the diaphragm driving section M2, and drive the CCD 103 through the CCD driving section M3.

When the REC mode is selected in the image capturing apparatus 100, image capturing preparations such as so-called preview display (also called “live view display”) for framing and auto-focus adjustment are carried out in the image capturing apparatus 100 prior to image capturing (actual image capturing) for acquiring image data to be recorded.

In actual image capturing, the microcomputer 106 compresses image data in the JPEG format. Then, the image data is transferred to the memory card 127 from the microcomputer 106 through a card driver 123, to be recorded on the memory card 127. At this time, the image data is encrypted by the microcomputer 106 in response to a user's operation of the operating section 109 before being recorded on the memory card 127. For encryption, various known techniques may be employed. Such encryption of image data of a captured image can limit output of the captured image in an external reproducing apparatus, and can protect image data of a captured image, even if stolen, from being easily replicated or abused.

The memory card 127 is designed to be removable from the image capturing apparatus 100. Although the memory card 127 is employed as an example of a recording medium for recording image data, another recording medium may be employed. Throughout this specification, an image of image data recorded on the memory card 127 will also be called “a captured image” as necessary.

In image capturing preparations, for example, live view display is provided on an LCD (finder LCD) 125 serving as a finder or the LCD (rear LCD) 126 provided almost at the center on the rear face of the image capturing apparatus 100, in accordance with settings. More specifically, when image data appropriately processed in the microcomputer 106 is transferred to the finder LCD 125 through an LCD driver 121, the image data is visibly output on the LCD 125. Alternatively, when image data is transferred to the rear LCD 126 from the microcomputer 106 through a LCD driver 122, the image data is visibly output on the rear LCD 126.

When the PLAY mode is selected in the image capturing apparatus 100, a captured image recorded on the memory card 127 can be reproduced on the rear LCD 126. More specifically, the microcomputer 106 reads image data recorded on the memory card 127 through a card driver 123 in response to a user's operation of the operating section 109, and transfers the image data to the rear LCD 126 through the LCD driver 122, so that the captured image can be reproduced on the rear LCD 126.

Once the PLAY mode is selected, a captured image most recently recorded on the memory card 127 is reproduced first on the rear LCD 126. A user can change the captured image to another sequentially by appropriately operating the operating section 109. For instance, pressing a frame-advance button (not shown), a captured image to be reproduced is changed to one of the next frame among captured images recorded on the memory card 127. Pressing a frame-return button (not shown), a captured image to be reproduced is changed to one of the previous frame among captured images recorded on the memory card 127.

A so-called radio frequency IC tag (hereinafter referred to as an “IC tag”) 124 is attached to a package of the image capturing apparatus 100.

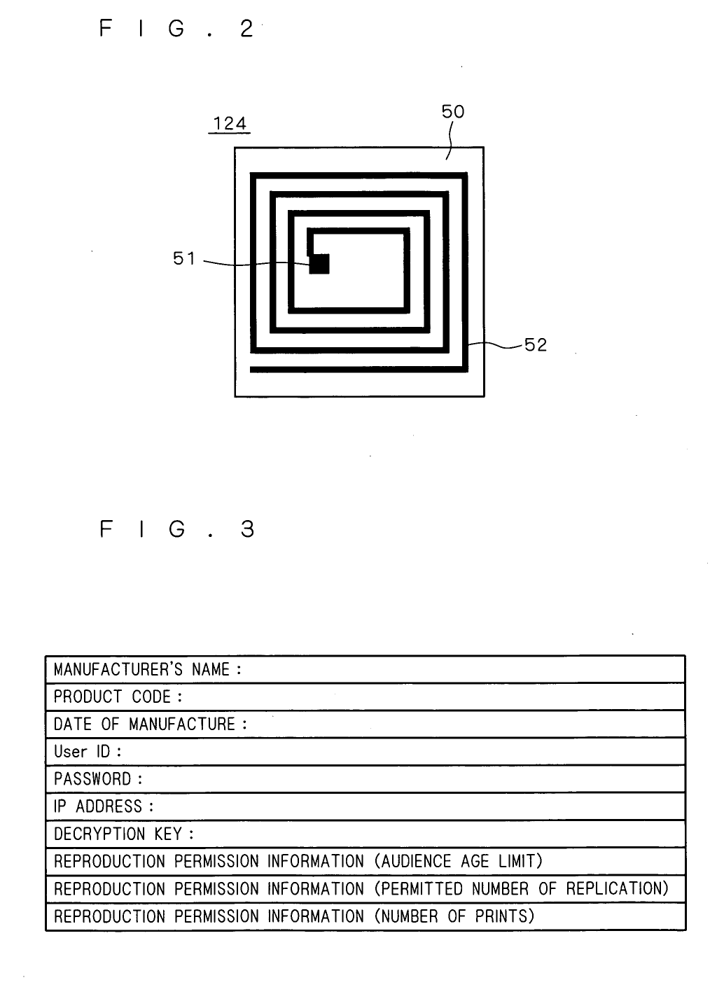

FIG. 2 illustrates a configuration of the IC tag 124. As shown in FIG. 2, the IC tag 124 is provided with a substrate part 50 having thereon a chip section 51 for storing tag information and an antenna section 52 formed of a spiral line drawn out from the chip section 51.

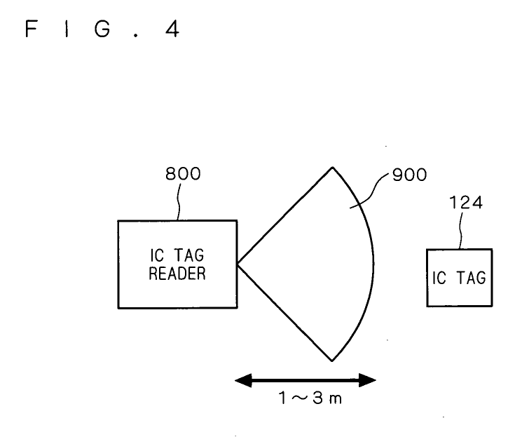

FIG. 3 illustrates data contents of tag information stored in the chip section 51. As shown in FIG. 3, the chip section 51 stores, as tag information, data on manufacturer's name, product code, date of manufacture, User ID, password, IP address, decryption key, reproduction permission information (audience age limit), reproduction permission information (permitted number of replication), and reproduction permission information (number of prints).

In the tag information stored in the IC tag 124, User ID, password and IP address constitute information (access information) permitting access to the image capturing apparatus 100 from external equipment through a network. For instance, User ID and password constitute authentication information for permitting access to the image capturing apparatus 100 from external equipment, and IP address is information to specify the image capturing apparatus 100 as a target of access from external equipment.

Decryption key, reproduction permission information (audience age limit), reproduction permission information (permitted number of replication), and reproduction permission information (number of prints) constitute information related to reproduction of a captured image recorded on the memory card 127 (hereinafter also referred to as “image reproduction information”). For instance, the decryption key is information for decoding encrypted image data of a captured image, and more specifically, for removing encryption limiting output of a captured image when reproducing the captured image in an external reproducing apparatus. Various known methods may be applied to such decryption. Reproduction permission information (audience age limit) is information for limiting output of a captured image in accordance with an age limit set in an external reproducing apparatus. Reproduction permission information (permitted number of replication) and reproduction permission information (number of prints) limit reproduction of a captured image in an external apparatus, such as replication and print, respectively.

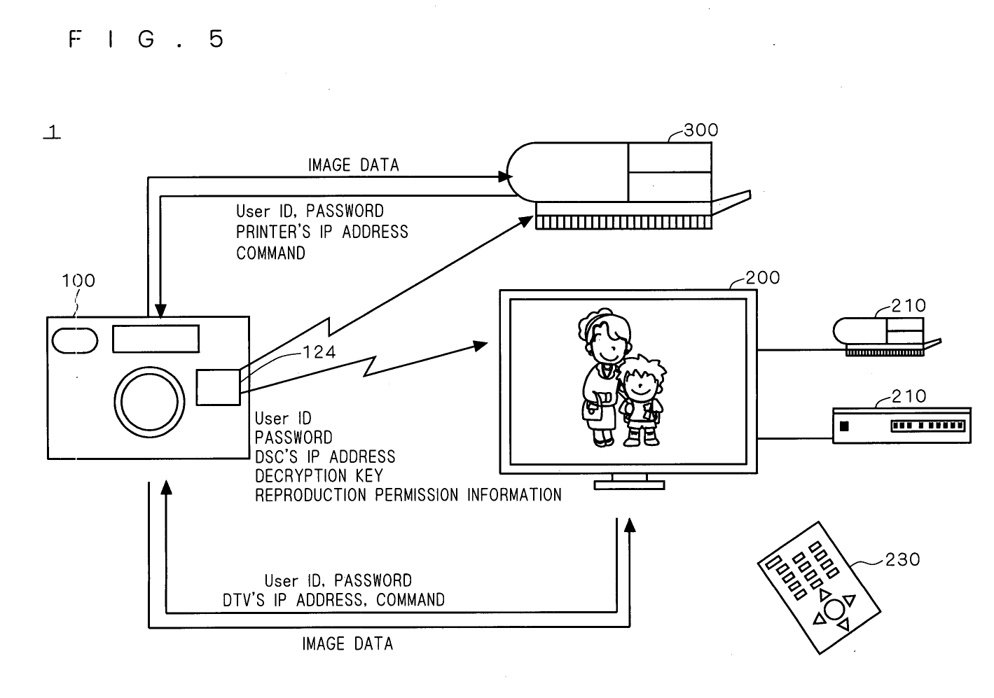

As shown in FIG. 4, when the IC tag 124 is made close to an IC tag reader 800 to enter a field 900 of an RF (radio frequency) signal produced by the IC tag reader 800, the IC tag 124 is supplied with power by the RF signal. The RF signal contains command data, and the IC tag 124 receives the data, and transmits tag information stored therein to the IC tag reader 800 by radio waves. The IC tag reader 800 thereby receives the tag information stored in the IC tag 124. The field 900 of the RF signal reaches a relatively short distance generally ranging from approximately 1 to 3 m, as shown in FIG. 4.

A network card 128 may be removably inserted into the image capturing apparatus 100. The image capturing apparatus 100 with the network card 128 inserted therein can physically be connected to an external LAN (Local Area Network).

Data Communications System

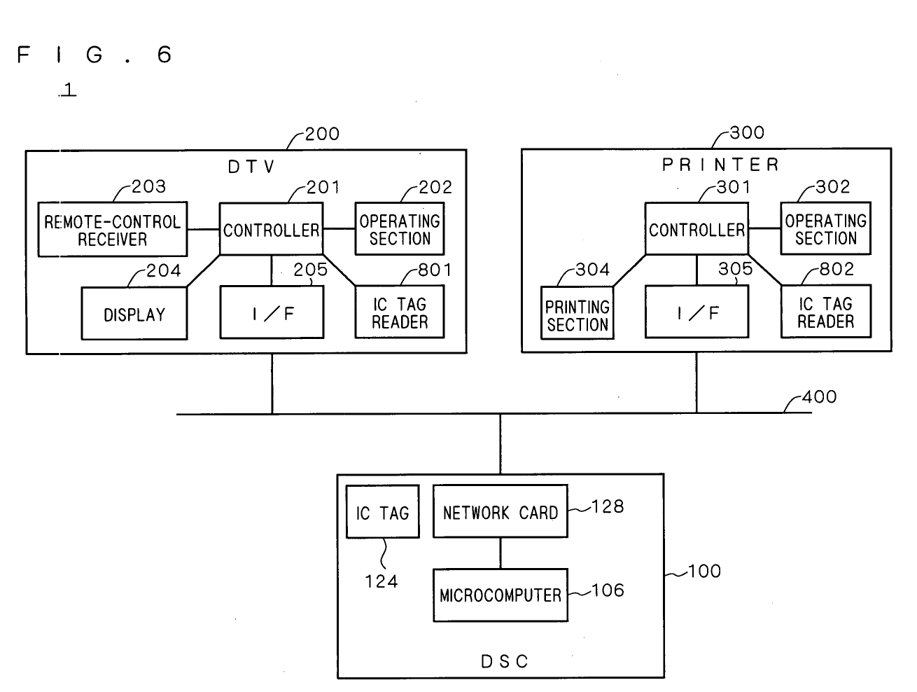

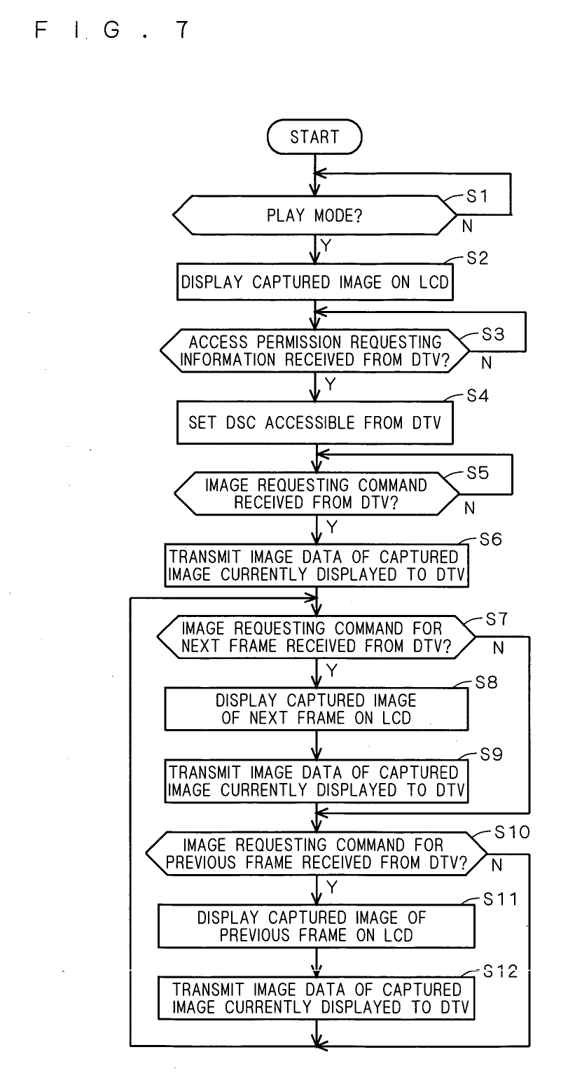

FIG. 5 generally illustrates a data communications system 1 according to the preferred embodiment of the present invention, and FIG. 6 is a functional block diagram illustrating the data communications system 1.

As shown in FIG. 5, the data communications system 1 mainly includes the image capturing apparatus 100, a digital television (DTV) 200 and a printer 300. A video printer 210 and a DVD recorder 220 are connected to the DTV 200 such that data communications can be made therebetween. A remote controller 230 for controlling the operation of the DTV 200 is supplied for the DTV 200.

As shown in FIG. 6, the DTV 200, printer 300 and the like are connected to one another through a LAN 400. Various types of LANs such as a home LAN may be applied to the LAN 400. The data communications system 1 is constructed by inserting the network card 128 into the image capturing apparatus 100 and connecting the image capturing apparatus 100 to the LAN 400 such that data communications can be made therebetween. The DTV 200 and printer 300 serve as reproducing apparatuses for visibly reproducing a captured image acquired by the image capturing apparatus 100.

In the data communications system 1 constructed as above described, the microcomputer 106 of the image capturing apparatus 100 carries out an authentication function of authenticating whether to permit access from the DTV 200 or printer 300. More specifically, when information (access permission requesting information) requesting permission to make access to the image capturing apparatus 100 through the LAN 400 is transmitted to the microcomputer 106 from the DTV 200 through the LAN 400, the microcomputer 106 permits access to the image capturing apparatus 100 from the DTV 200 through the LAN 400. The access permission requesting information contains authentication information such as User ID and password. The printer 300 is also permitted to make access to the image capturing apparatus 100 by a similar method.

The DTV 200 mainly includes a controller 201, an operating section 202, a remote-control receiver 203, a display 204, an interface (I/F) 205 and an IC tag reader 801.

The controller 201 controls the DTV 200 as a whole. The controller 201 is provided with CPU, RAM, ROM and the like. The CPU reads and executes a program stored in the ROM, so that various types of control and functions are achieved.

According to the above-described method, the IC tag reader 801 receives the tag information from the IC tag 124 attached to the image capturing apparatus 100, and transfers the received tag information to the controller 201. Then, the controller 201 performs an operation in accordance with the type of transferred data. When a captured-image display mode which will be described later is selected in the DTV 200, the IC tag reader 801 produces an RF signal so as to become able to read the tag information stored in the IC tag 124.

The operating section 202 has various buttons and switches and the like, and transmits various signals to the controller 201 in accordance with a user's operation. When the operating section 202 is operated appropriately, a mode (also referred to as a “captured-image display mode”) for receiving image data of a captured image from the image capturing apparatus 100 through the LAN 400 and displaying the image data is selected in the DTV 200 by the controller 201.

The remote-control receiver 203 receives a signal from the remote controller 230 and transfers the signal to the controller 201. The controller 201 performs operations in accordance with various signals transmitted from the operating section 202 and remote controller 230.

The display 204 displays various images under the control of the controller 201. For instance, image data of a captured image is received from the image capturing apparatus 100 through the LAN 400 and is visibly output on the display 204, so that the captured image can be reproduced. Reproduction of a captured image on the display 204 will be described later.

The I/F 205 makes data communications with the image capturing apparatus 100 or the like through the LAN 400. For instance, the I/F 205 transmits a signai received from the controller 201 to the image capturing apparatus 100, and transfers data received from the image capturing apparatus 100 to the controller 201. Although illustration is omitted in FIG. 6, the I/F 205 also controls data communications between the controller 201 and video printer 210 or DVD recorder 220.

The printer 300 mainly includes a controller 301, an operating section 302, a printing section 304, an interface I/F 305 and an IC tag reader 802.

The controller 301 controls the printer 300 as a whole. The controller 301 has CPU, RAM, ROM and the like. The CPU reads and executes a program stored in the ROM, so that various types of control and functions are achieved.

According to the above-described method, the IC tag reader 802 receives tag information from the IC tag 124 attached to the image capturing apparatus 100, and transfers the received tag information to the controller 301. Then, the controller 301 performs an operation in accordance with the type of transferred data. When a captured-image print mode which will be described later is selected in the printer 300, the IC tag reader 802 produces an RF signal so as to become able to read the tag information stored in the IC tag 124.

The operating section 302 has an operation panel with various buttons, switches and the like, and transmits various signals to the controller 301 in accordance with a user's operation. When the operating section 302 is operated appropriately, a mode (also referred to as a “captured-image print mode”) for printing image data of a captured image received from the image capturing apparatus 100 through the LAN 400 is selected in the printer 300 by the controller 301.

The printing section 304 prints out various types of images under the control of the controller 301. For instance, image data of a captured image is received from the image capturing apparatus 100 through the LAN 400 and is visibly output in the printing section 304, so that the captured image can be reproduced. Reproduction of a captured image in the printing section 304 will be described later.

The I/F 305 makes data communications with the image capturing apparatus 100 or the like through the LAN 400. For instance, the I/F 305 transmits a signal received from the controller 301 to the image capturing apparatus 100, and transfers data received from the image capturing apparatus 100 to the controller 301.

Reproduction of a captured image in the DTV 200 and printer 300 will now be described, respectively.

Image Reproduction in DTV

Reproduction of a captured image in the DTV 200 is achieved by transmission of image data of the captured image from the image capturing apparatus 100 to the DTV 200 through the LAN 400, that is, mutual cooperation between the operation of the image capturing apparatus 100 and that of the DTV 200.

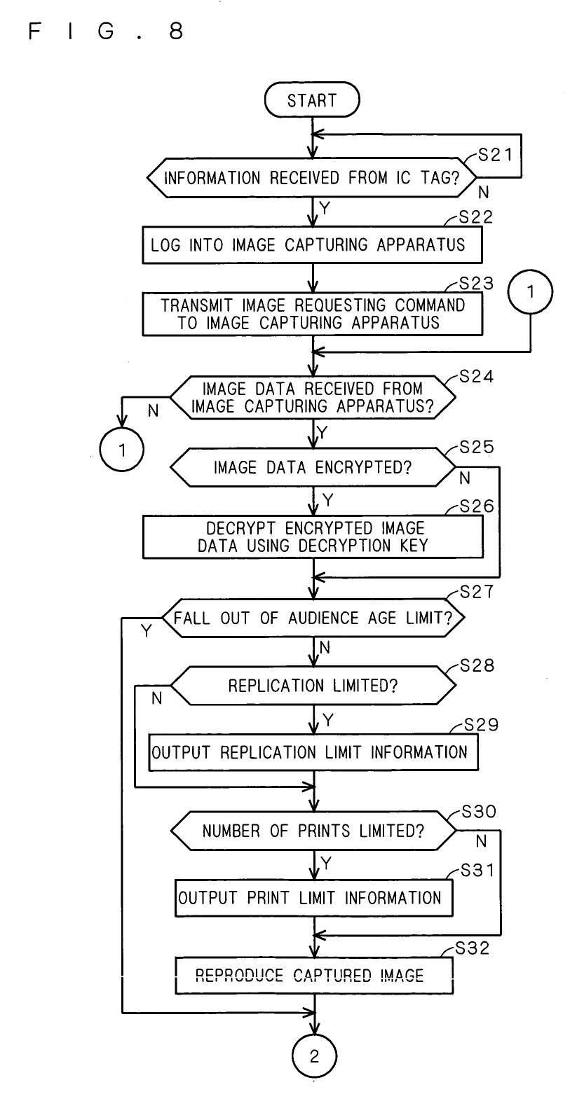

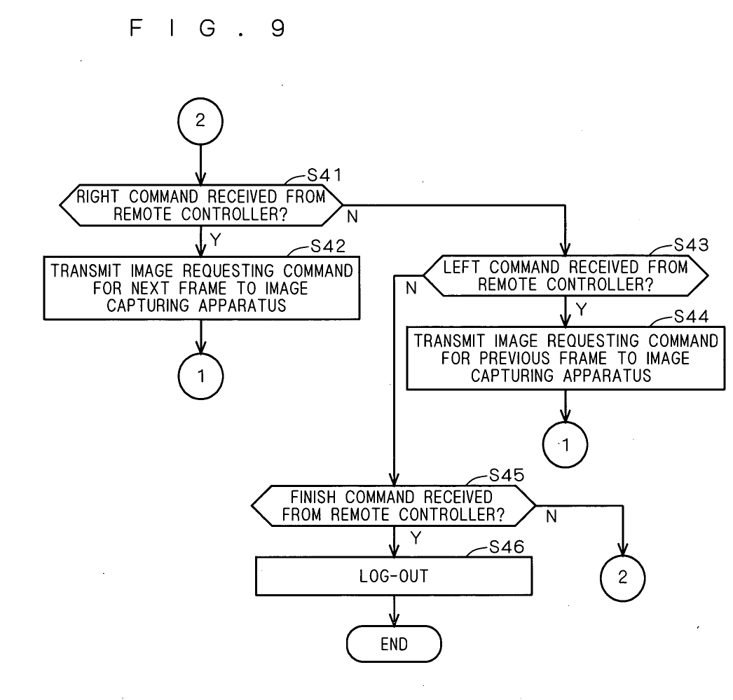

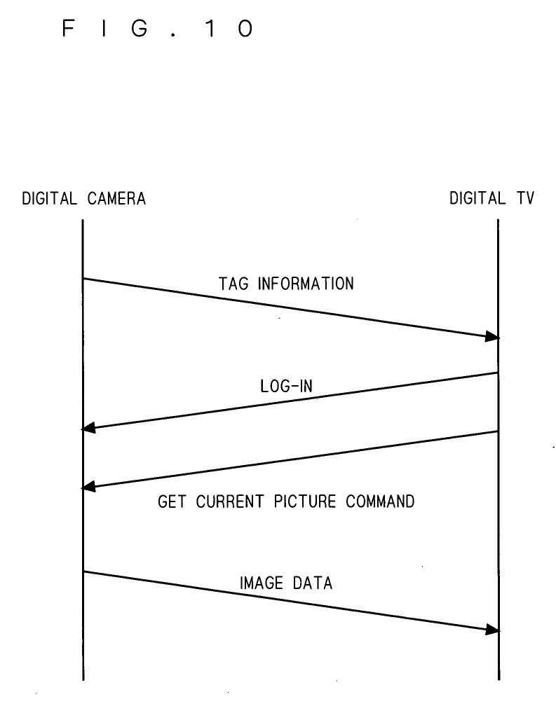

FIG. 7 is a flow chart showing the operation of the image capturing apparatus 100 when reproducing a captured image in the DTV 200. FIGS. 8 and 9 are flow charts showing the operation of the DTV 200 when reproducing the captured image in the DTV 200.

The operation shown in FIG. 7 is executed under the control of the microcomputer 106 in the image capturing apparatus 100, and the operation shown in FIGS. 8 and 9 is executed under the control of the controller 201 in the DTV 200. The operation of the image capturing apparatus 100 shown in FIG. 7 and that of the DTV 200 shown in FIGS. 8 and 9 are performed in parallel, so that reproduction of a captured image in the DTV 200 is achieved.

The operations in the image capturing apparatus 100 and DTV 200 are performed in parallel, but will be described individually to avoid complicated description.

First, referring to the flow chart of FIG. 7, the operation of the image capturing apparatus 100 will be described. When a user manually connects the image capturing apparatus 100 physically to the LAN 400 with the network card 128, the operation shown in FIG. 7 is started.

In step S1, it is judged whether or not the PLAY mode is selected in the image capturing apparatus 100. The judgment in step S1 is repeated until the PLAY mode is selected. When the PLAY mode is selected, the process proceeds into step S2.

In step S2, image data of a captured image recorded on the memory card 127 is visibly output on the rear LCD 126. Here, the most recently recorded one of captured images recorded on the memory card 127 is displayed. A captured image coming first when sorting captured images stored on the memory card 127 by filename may be displayed on the rear LCD 126.

In step S3, it is judged whether or not access permission requesting information (containing authentication information such as User ID and password) has been received from the DTV 200. The judgment in step S3 is repeated until the access permission requesting information is received. When the access permission requesting information is received, the process proceeds into step S4.

In step S4, the image capturing apparatus 100 is set accessible from the DTV 200 based on the authentication information received from the DTV 200.

In step S5, it is judged whether or not a command requesting transmission of image data of a captured image currently displayed (also referred to as an “image requesting command” or “Get Current Picture command”) has been received from the DTV 200 through the LAN 400. The judgment in step S5 is repeated until the image requesting command is received. When the image requesting command is received, the process proceeds into step S6.

In step S6, image data of the captured image currently displayed on the rear LCD 126 is transmitted to the DTV 200 through the LAN 400.

In step S7, it is judged whether or not an image requesting command for the next frame has been received from the DTV 200 through the LAN 400. When a command (Next Picture command) requesting the next frame to be displayed and the image requesting command are received from the DTV 200, the process proceeds into step S8 judging that the image requesting command for the next frame has been received. When such commands are not received, the process proceeds into step S10.

In step S8, among captured images recorded on the memory card 127, a captured image of the next frame of the captured image currently displayed on the rear LCD 126 is displayed on the rear LCD 126.

In step S9, image data of the captured image currently displayed on the rear LCD 126 is transmitted to the DTV 200 through the LAN 400.

In step S10, it is judged whether or not the image requesting command for a previous frame has been received from the DTV 200 through the LAN 400. When a command (Prev Picture command) requesting a previous frame to be displayed and the image requesting command are received from the DTV 200, the process proceeds into step S11 judging that the image requesting command for the previous frame has been received. When such commands are not received, the process returns to step S7.

In step S11, among captured images recorded on the memory card 127, a captured image of the previous frame of the captured image currently displayed on the rear LCD 126 is displayed on the rear LCD 126.

In step S12, image data of the captured image currently displayed on the rear LCD 126 is transmitted to the DTV 200 through the LAN 400.

When a user manually removes the network card 128 from the image capturing apparatus 100, the operation shown in FIG. 7 can forcedly be finished.

Next, the operation of the DTV 200 will be described referring to the flow charts of FIGS. 8 and 9. When a user operates the operating section 202 appropriately, the captured-image display mode is selected in the DTV 200, and the operation shown in FIG. 8 is started.

In step S21, it is judged whether or not the tag information has been received from the IC tag 124. The judgment in step S21 is repeated until the tag information is received by the IC reader 801. When the tag information is received, the process proceeds into step S22. When the IC tag reader 801 and IC tag 124 are close to each other, the IC tag reader 801 can receive the tag information stored in the IC tag 124.

When proceeding from step S21 to step S22, the IC tag reader 801 receives access information such as User ID, password and IP address, and besides, various types of information such as decryption key, reproduction permission information (audience age limit), reproduction permission information (permitted number of replication), and reproduction permission information (number of prints).

In step S22, a user logs into the image capturing apparatus 100 through the LAN 400 based on the access information received by the IC tag reader 801. The image capturing apparatus 100 is specified as a target of access in accordance with the IP address, so that the access permission requesting information (containing the authentication information such as User ID and password) is transmitted to the image capturing apparatus 100. The DTV 200 is thereby permitted to make access to various resources of the image capturing apparatus 100.

In step S23, a command requesting transmission of a captured image (image requesting command) is transmitted to the image capturing apparatus 100 through the LAN 400.

In step S24, it is judged whether or not image data of a captured image has been received from the image capturing apparatus 100 through the LAN 400. The judgment in step S24 is repeated until image data is received. When image data is received, the process proceeds into step S25.

In step S25, it is judged whether or not the image data received from the image capturing apparatus 100 is encrypted. When the image data is encrypted, the process proceeds into step S26. When the image data is not encrypted, the process proceeds into step S27.

In step S26, the image data received from the image capturing apparatus 100 is decrypted using the decryption key. In this manner, limits can be imposed such that a captured image cannot be reproduced unless the decryption key is obtained by the IC tag reader 801 located close to the image capturing apparatus 100. That is, the decryption key stored in the IC tag 124 limits output such that a captured image can be reproduced only by equipment located close to the image capturing apparatus 100.

In step S27, it is judged whether or not a user falls out of the audience age limit by comparing the audience age limit previously stored in the DTV 200 and the reproduction permission information (audience age limit) contained in the tag information received from the IC tag 124.

More specifically, indicating the age set in the DTV 200 by a first age and the reproduction permission information (audience age limit) contained in the tag information by a second age, a user falls out of the audience age limit when the first age is less than the second age. When the first age is equal to or greater than the second age, the user falls within the audience age limit. For instance, when the age set in the DTV 200 is sixteen, and the reproduction permission information (audience age limit) contained in the tag information indicates seventeen, the user falls out of the audience age limit.

When it is judged in step S27 that the user falls out of the audience age limit, the process proceeds into step S41 shown in FIG. 9. When it is judged that the user falls within the audience age limit, the process proceeds into step S28.

In step S28, it is judged whether or not replication is limited (i.e., whether there is a replication limit). When the tag information received from the IC tag 124 contains reproduction permission information (permitted number of replication), the process proceeds into step S29 judging that there is a replication limit. When the tag information does not contain reproduction permission information (permitted number of replication), the process proceeds into step S30 judging that there is no replication limit.

The permitted number of replication indicates the number that a captured image can be replicated by the DVD recorder 220 connected to the DTV 200. Such limit on the permitted number of replication can be achieved by controlling the number of replication by the controller 201 to limit transmission of image data of a captured image between the DTV 200 and DVD recorder 220.

In step S29, the controller 201 exerts control such that information indicating the permitted number of replication (replication limit information) is visibly output on the display 204 in accordance with the reproduction permission information (number of replication). For instance, a sentence indicating the permitted number of replication such as “replication is permitted up to twice” is displayed on the right lower part of the display 204.

In step S30, it is judged whether or not the number of prints is limited (i.e., whether there is a print limit). When the tag information received from the IC tag 124 contains reproduction permission information (number of prints), the process proceeds into step S31 judging that there is a print limit. When the tag information does not contain reproduction permission information (number of prints), the process proceeds into step S32 judging that there is no print limit.

In step S31, the controller 201 exerts control such that information indicating the upper limit of the number of prints (print limit information) is visibly output on the display 204 in accordance with the reproduction permission information (number of prints). For instance, a sentence indicating the number of replication such as “printing is permitted up to 3 pages” is displayed on the right lower part of the display 204.

The number of prints means the number of pages of a captured image that can be printed by the video printer 210 connected to the DTV 200. Such limit can be achieved by controlling the number of prints by the controller 201 to limit transmission of image data of a captured image between the DTV 200 and video printer 210.

In step S32, a captured image is reproduced on the display 204 based on the image data received from the image capturing apparatus 100, and the process proceeds into step S41 shown in FIG. 9. When the replication limit information and/or number-of-prints limit information are/is visibly output in step S29 and/or S31, the captured image is visibly output with the permitted number of replication and/or number of prints superimposed thereon.

In step S41, it is judged whether or not the controller 201 has received a command designating the right side (Right command) from the remote controller 230. When the Right command is received from the remote controller 230 by a user's appropriate operation of the remote controller 230, the process proceeds into step S42. When the Right command is not received, the process proceeds into step S43.

In step S42, the controller 201 transmits an image requesting command requesting an image of the next frame to the image capturing apparatus 100 through the LAN 400. More specifically, a command requesting the next frame to be displayed (Next Picture command) and image requesting command are transmitted. To make the Right command received from the remote controller 230 and the Next Picture command correspond to each other, information for making the Right command and Next Picture command correspond to each other may be added to the tag information stored in the IC tag 124.

In step S43, it is judged whether or not a command designating the left side (Left command) has been received from the remote controller 230. The judgment is made by a user's appropriate operation of the remote controller 230. When the Left command is received from the remote controller 230, the process proceeds into step S44, and when the Left command is not received, the process proceeds into step S45.

In step S44, the controller 201 transmits an image requesting command requesting an image of a previous frame to the image capturing apparatus 100 through the LAN 400, and the process returns to step S24. More specifically, a command requesting the previous frame to be displayed (Prev Picture command) and image requesting command are transmitted. To make the Left command received from the remote controller 230 and the Prev Picture command correspond to each other, information for making the Left command and the Prev Picture command correspond to each other may be added to the tag information of the IC tag 124.

In step S45, it is judged whether or not a command for finishing the reproduction of a captured image (finish command) has been received from the remote controller 230. When the finish command is received from the remote controller 230 by a user's appropriate operation of the remote controller 230, the process proceeds into step S46. When the finish command is not received, the process returns to step S41. That is, unless the finish command is received in accordance with a user's operation of the remote controller 230, the display 204 continues displaying a captured image currently displayed or displays a captured image of the next frame or previous frame by switching as necessary.

In step S46, the user logs out to reset accessibility to the image capturing apparatus 100, thereby finishing the operation.

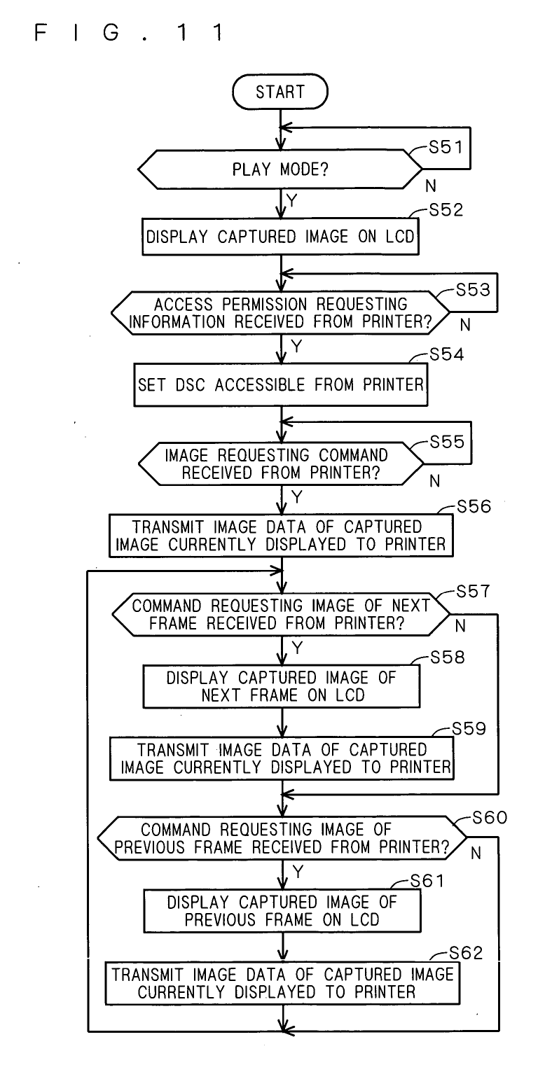

FIG. 10 briefly illustrates data communications between the image capturing apparatus 100 and DTV 200 when reproducing a captured image in the DTV 200.

As shown in FIG. 10, when the DTV 200 receives the tag information from the image capturing apparatus 100, a user logs into the image capturing apparatus 100 using the tag information while the DTV 200 transmits a Get Current Picture command to the image capturing apparatus 100 through the LAN 400. In response to this command, the image capturing apparatus 100 transmits image data of a captured image to the DTV 200 through the LAN 400. With such data communications, the captured image acquired by the image capturing apparatus 100 can be displayed on the DTV 200 located close to the image capturing apparatus 100.

Image Reproduction in Printer

Reproduction of a captured image in the printer 300 is achieved by transmitting image data of the captured image from the image capturing apparatus 100 to the printer 300 through the LAN 400. Thus, reproduction of the captured image on the. printer 300 is achieved by mutual cooperation between the operation of the image capturing apparatus 100 and that of the printer 300.

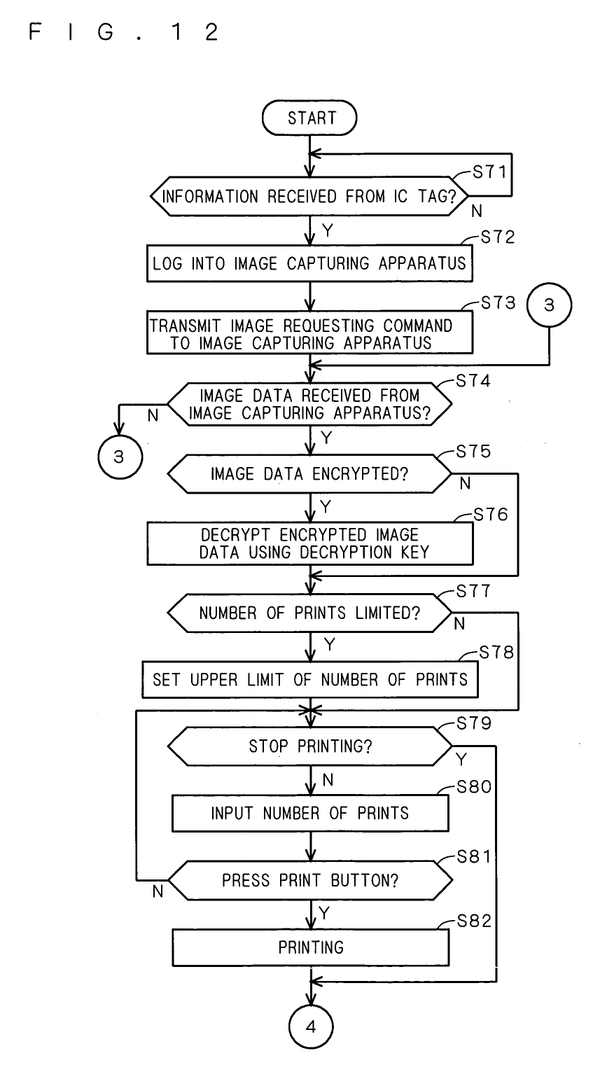

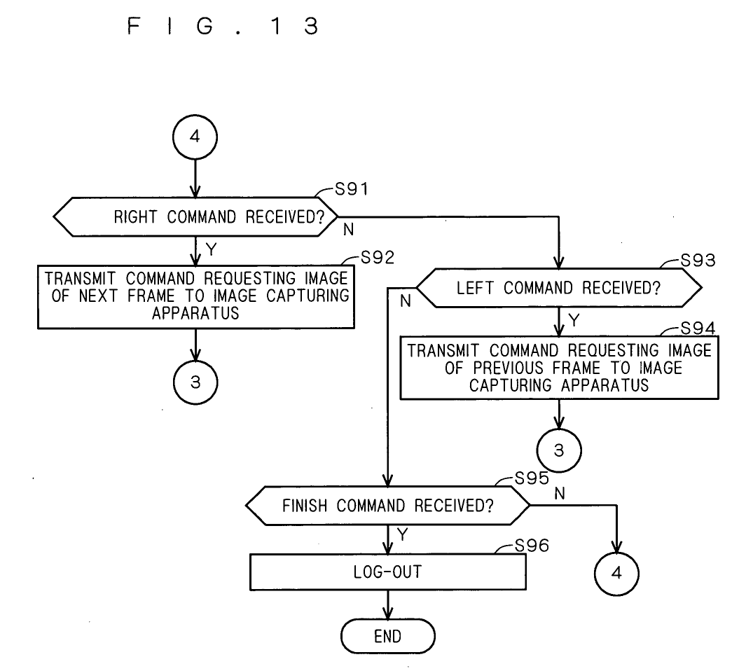

FIG. 11 is a flow chart showing the operation of the image capturing apparatus 100 when reproducing a captured image in the printer 300. FIGS. 12 and 13 are flow charts showing the operation of the printer 300 when reproducing the captured image in the printer 300.

The operation shown in the flow chart of FIG. 11 is executed under the control of the microcomputer 106 in the image capturing apparatus 100, and the operation shown in the flow charts of FIGS. 12 and 13 is executed under the control of the controller 301 in the printer 300. The operation of the image capturing apparatus 100 shown in FIG. 11 and that of the printer 300 shown in FIGS. 12 and 13 are performed in parallel, so that reproduction of a captured image in the printer 300 is achieved.

The operations in the image capturing apparatus 100 and printer 300 are performed in parallel, but will be described individually to avoid complicated description.

First, referring to the flow chart of FIG. 11, the operation of the image capturing apparatus 100 will be described. When a user manually connects the image capturing apparatus 100 physically to the LAN 400 with the network card 128, the operation shown in FIG. 11 is started.

In step S51, it is judged whether or not the PLAY mode is selected in the image capturing apparatus 100. The judgment in step S51 is repeated until the PLAY mode is selected. When the PLAY mode is selected, the process proceeds into step S52.

In step S52, image data of a captured image recorded on the memory card 127 is visibly output on the rear LCD 126. Here, the most recently recorded one of captured images recorded on the memory card 127 is displayed.

In step S53, it is judged whether or not access permission requesting information (containing authentication information such as User ID and password) has been received from the printer 300. The judgment in step S53 is repeated until the access permission requesting information is received. When the access permission requesting information is received, the process proceeds into step S54.

In step S54, the image capturing apparatus 100 is set accessible from the printer 300 based on the authentication information received in step S53.

In step S55, it is judged whether or not a command (also referred to as an “image requesting command” or “Get Current Picture command”) requesting transmission of image data of a captured image currently displayed has been received from the printer 300 through the LAN 400. The judgment in step S55 is repeated until the image requesting command is received. When the image requesting command is received, the process proceeds into step S56.

In step S56, image data of the captured image currently displayed on the rear LCD 126 is transmitted to the printer 300 through the LAN 400.

In step S57, it is judged whether or not the image requesting command for the next frame has been received from the printer 300 through the LAN 400. When a command requesting the next frame to be displayed (Next Picture command) and image requesting command are received from the printer 300, the process proceeds into step S58 judging that the image requesting command for the next frame has been received. When such commands are not received, the process proceeds into step S60.

In step S58, among captured images recorded on the memory card 127, one of the next frame of the captured image currently displayed on the rear LCD 126 is displayed on the rear LCD 126.

In step S59, image data of the captured image currently displayed on the rear LCD 126 is transmitted to the printer 300 through the LAN 400.

In step S60, it is judged whether or not the image requesting command for a previous frame has been received from the printer 300 through the LAN 400. When a command requesting a previous frame to be displayed (Prev Picture command) and image requesting command are received from the printer 300, the process proceeds into step S61 judging that the image requesting command for the previous frame has been received. When such commands are not received, the process returns to step S57.

In step S61, among captured images recorded on the memory card 127, one of the previous frame of the captured image currently displayed on the rear LCD 126 is displayed on the rear LCD 126.

In step S62, image data of the captured image currently displayed on the rear LCD 126 is transmitted to the printer 300 through the LAN 400.

When a user manually removes the network card 128 from the image capturing apparatus 100, the operation shown in FIG. 11 can be forcedly finished.

Next, the operation of the printer 300 will be described referring to the flow charts of FIGS. 12 and 13. When a user operates the operating section 302 appropriately, the captured-image print mode is selected in the printer 300, and the operation shown in FIG. 12 is started.

In step S71, it is judged whether or not the tag information has been received from the IC tag 124. The judgment in step S71 is repeated until the tag information is received by the IC tag reader 802. When the tag information is received, the process proceeds into step S72. When the IC tag reader 802 and IC tag 124 are close to each other, the IC tag reader 802 can receive the tag information stored in the IC tag 124.

When proceeding from step S71 to step S72, the IC tag reader 802 receives access information such as User ID, password and IP address, and besides, various types of information such as decryption key, reproduction permission information (audience age limit), reproduction permission information (permitted number of replication), and reproduction permission information (number of prints).

In step S72, a user logs into the image capturing apparatus 100 through the LAN 400 based on the access information received by the IC tag reader 802. The image capturing apparatus 100 is specified as a target of access in accordance with the IP address, so that the access permission requesting information (containing the authentication information such as User ID and password) is transmitted to the image capturing apparatus 100. The printer 300 is thereby permitted to make access to various resources of the image capturing apparatus 100.

In step S73, a command requesting transmission of a captured image (image requesting command) is transmitted to the image capturing apparatus 100 through the LAN 400.

In step S74, it is judged whether or not image data of a captured image has been received from the image capturing apparatus 100 through the LAN 400. The judgment in step S74 is repeated until image data is received. When image data is received, the process proceeds into step S75.

In step S75, it is judged whether or not the image data received from the image capturing apparatus 100 is encrypted. When the image data is encrypted, the process proceeds into step S76. When the image data is not encrypted, the process proceeds into step S77.

In step S76, the image data received from the image capturing apparatus 100 is decrypted using the decryption key. In this manner, limits can be imposed such that a captured image cannot be reproduced unless the decryption key is obtained by the IC tag reader 802 located close to the image capturing apparatus 100.

In step S77, it is judged whether or not the number of prints is limited (i.e., whether there is a print limit). When the tag information received from the IC tag 124 contains reproduction permission information (number of prints), the process proceeds into step S78 judging that there is a print limit. When the tag information does not contain reproduction permission information (number of prints), the process proceeds into step S79 judging that there is no print limit.

In step S78, the upper limit of the number of prints is determined in accordance with the reproduction permission information (number of prints) received from the IC tag 124.

In step S79, it is judged whether or not printing is stopped. When a user presses a button (print stop button) of the operating section 302 for stopping printing, the process proceeds into step S91 shown in FIG. 13 judging that printing is to be stopped. When the user does not press the print stop button of the operating section 302, the process proceeds into step S80 judging that printing is not to be stopped.

In step S80, an input of the number of prints is received. The number of prints can be input by a user's appropriate operation of the operating section 302 within a range not exceeding the upper limit of the number of prints determined in step S78. As will be described later, in the case where the process returns from step S81 to S79, step S80 is to be performed for a second time or more. Since the number of prints has already been input once in the case where step S80 is performed for a second time or more, the process proceeds into step S81 unless the number of prints is newly input in a predetermined time period.

In step S81, it is judged whether or not a print button of the operating section 302 is pressed. When the print button is pressed, the process proceeds into step S82, and when the print button is not pressed, the process returns to step S79.

Here, the user determines the number of prints and presses the print button looking at a captured image displayed on the rear LCD 126 of the image capturing apparatus 100. A captured image may be displayed in small scale on the operation panel of the printer 300, and the user may determine the number of prints and press the print button looking at the captured image.

In step S82, the captured image is printed in the printing section 304 in accordance with image data received from the image capturing apparatus 100. In this manner, a captured image currently displayed on the rear LCD 126 of the image capturing apparatus 100 can be reproduced on a printing paper output from the printing section 304.

In step S91, it is judged whether or not the controller 301 has received a command designating the right side (Right command) from the operating section 302. When the Right command is received from the operating section 302 by a user's appropriate operation of the operating section 302, the process proceeds into step S92. When the Right command is not received, the process proceeds into step S93.

In step S92, the controller 301 transmits an image requesting command requesting an image of the next frame to the image capturing apparatus 100 through the LAN 400. More specifically, a command requesting the next frame to be displayed (Next Picture command) and image requesting command are transmitted. To make the Right command and Next Picture command correspond to each other, information for making the Right command and the Next Picture command correspond to each other may be added to the tag information stored in the IC tag 124.

In step S93, it is judged whether or not a command designating the left side (Left command) has been received from the operating section 302. The judgment is made by a user's appropriate operation of the operating section 302. When the Left command is received from the operating section 302, the process proceeds into step S94. When the Left command is not received, the process proceeds into step S95.

In step S94, the controller 301 transmits an image requesting command requesting an image of a previous frame to the image capturing apparatus 100 through the LAN 400, and the process returns to step S74. More specifically, a command requesting the previous frame to be displayed (Prev Picture command) and image requesting command are transmitted. To make the Left command received from the operating section 302 and Prev Picture command correspond to each other, information for making the Left command and Prev Picture command correspond to each other may be added to the tag information stored in the IC tag 124.

In step S95, it is judged whether or not a command for finishing the reproduction of a captured image (finish command) has been received from the operating section 302. When the finish command is received from the operating section 302 by a user's appropriate operation of the operating section 302, the process proceeds into step S96. When the finish command is not received, the process returns to step S91.

As described, unless the finish command is received in accordance with a user's operation of the operating section 302, a captured image currently displayed in the image capturing apparatus 100 may be printed or a captured image of the next frame or previous frame may be printed by appropriately switching from a captured image currently displayed.

In step S96, a user logs out to reset accessibility to the image capturing apparatus 100, thereby finishing the operation.

As described, in the data communications system 1 according to the preferred embodiment of the invention, the IC tag 124 is attached to the image capturing apparatus 100. This IC tag 124 stores, as tag information, access information for permitting access to the image capturing apparatus 100 through a network. In this state, a user of a reproducing apparatus (in this case, DTV 200 or printer 300) logs into the image capturing apparatus 100 based on the access information received from the IC tag 124, so that the reproducing apparatus transmits an image requesting command to the image capturing apparatus 100. In response to the image requesting command, the image capturing apparatus 100 transmits image data of a captured image currently displayed on the rear LCD 126 to the reproducing apparatus. The reproducing apparatus thereby receives the image data from the image capturing apparatus 100 and visibly outputs the image data.

With such arrangement, a captured image acquired by the image capturing apparatus 100 can easily be reproduced by a reproducing apparatus only by making the image capturing apparatus 100 close to the reproducing apparatus. Further, a captured image can be reproduced only in a reproducing apparatus located physically close to the image capturing apparatus 100. For instance, it is possible to protect against access to an image capturing apparatus located in a house through a network from a distance, e.g., from outside the house.

Furthermore, a captured image could have been reproduced only by removing a recording medium storing image data of the captured image from an image capturing apparatus and inputting the image data into a computer or predetermined TV; however, the data communications system 1 allows easy reproduction of a captured image in a reproducing apparatus only by making an image capturing apparatus close to the reproducing apparatus without the trouble of inputting User ID or password. Therefore, it is possible to easily connect the image capturing apparatus and reproducing apparatus through a network while ensuring security.

The access information stored in the IC tag 124 contains authentication information for permitting access to the image capturing apparatus 100. Thus, it is possible to limit a reproducing apparatus that can make access to the image capturing apparatus 100 to one that has received the access information from the image capturing apparatus 100 made close thereto. More specifically, a reproducing apparatus that can make access to the image capturing apparatus 100 can easily be limited since the authentication information stored in the IC tag 124 contains User ID and password.

Further, the reproducing apparatus such as the DTV 200 or printer 300 receives information about reproduction of a captured image (image reproduction information) stored in the IC tag 124 such as decryption key, reproduction permission information (audience age limit), reproduction permission information (permitted number of replication), and reproduction permission information (number of prints) by means of the IC tag reader 801 or 802. Then, the reproducing apparatus controls output of image data of a captured image based on the image reproduction information. With such arrangement, output of an image can easily be controlled.

Furthermore, the image reproduction information contains information for limiting output of a captured image when reproducing the captured image in a reproducing apparatus or the like, such as encryption key and reproduction permission information (audience age limit). With such arrangement, limits can easily be imposed on image reproduction.

Variant

The preferred embodiment of the present invention has been described, however, the present invention is not limited to the above description.

For instance, the above preferred embodiment has described, by way of example, the DTV 200 and printer 300 as a reproducing apparatus for reproducing a captured image. However, this is only an illustrative example, and the reproducing apparatus may be any apparatus that visibly reproduces a captured image such as a personal computer or a projector.

Further, the access permission requesting information contains User ID and password in the above preferred embodiment, but this is only an illustrative example, and similar effects to those of the above embodiment can be achieved only if at least one of User ID and password is contained. That is, it is possible to easily limit a reproducing apparatus that can make access to the image capturing apparatus 100 to one that has received the access information from the image capturing apparatus 100 made close thereto.

The “RF IC tag” mentioned throughout this specification includes an IC chip for transmitting information by radio waves and the like, as a matter of course. A device for transmitting various types of information such as access information from the image capturing apparatus 100 by radio waves is not limited to the RF IC tag, but may be another RF device (infrared interface, Bluetooth or the like) that can transmit data in a short distance.

An IC tag into which information is writable once by an external IC tag writer or an IC tag whose information stored therein is rewritable may be employed as the IC tag 124.

The “network” mentioned throughout this specification indicates a communication network for transmitting data or the like.

While the invention has been shown and described in detail, the foregoing description is in all aspects illustrative and not restrictive. It is therefore understood that numerous modifications and variations can be devised without departing from the scope of the invention.

What is claimed is:

1. A data communications system comprising an image capturing apparatus and a reproducing apparatus, wherein
said image capturing apparatus includes:
a radio frequency device storing access information for permitting said reproducing apparatus to make access to said image capturing apparatus; and
an image data transmitter for transmitting image data to said reproducing apparatus having made access to said image capturing apparatus, and
said reproducing apparatus includes:
a receiver for receiving said access information from said radio frequency device;
an access controller for making access to said image capturing apparatus based on said access information received by said receiver; and
a reproducer for reproducing image data transmitted from said image data transmitter.

2. The data communications system according to claim 1, wherein
said radio frequency device is an IC tag.

3. The data communications system according to claim 1, wherein
said image capturing apparatus and said reproducing apparatus are connected through a network, and
said access information contains an IP address in said network.

4. The data communications system according to claim 1, wherein
said image capturing apparatus and said reproducing apparatus are connected through a network, and
said access information contains authentication information for permitting said reproducing apparatus to make access to said image capturing apparatus through said network.

5. The data communications system according to claim 4, wherein
said authentication information contains at least one of a user ID and a password.

6. The data communications system according to claim 4, wherein
said access controller requests said image capturing apparatus to give access permission through said network, and
said image data transmitter transmits said image data to said reproducing apparatus through said network with said reproducing apparatus permitted to make access to said image capturing apparatus through said network.

7. The data communications system according to claim 1, wherein
said radio frequency device further stores image reproduction information related to image reproduction,
said receiver receives said image reproduction information, and
said reproducer controls reproduction of said image data based on said reproduction information received by said receiver.

8. The data communications system according to claim 7, wherein
said image reproduction information is information related to a limit imposed on output of said image data.

9. The data communications system according to claim 8, wherein
said information related to a limit imposed on output of said image data is information for reproducing an encrypted image.

10. The data communications system according to claim 8, wherein
said information related to a limit imposed on output of said image data contains at least one of information related to an age limit of audience of image data, information related to a replication limit and information related to a print limit.

11. An image capturing apparatus comprising:
a radio frequency device storing access information for permitting a predetermined reproducing apparatus to make access to said image capturing apparatus;
a controller for receiving an access request from said predetermined reproducing apparatus having received said access information from said radio frequency device; and
an image data transmitter for transmitting image data to said predetermined reproducing apparatus having made access to said image capturing apparatus.

12. The image capturing apparatus according to claim 11, wherein
said radio frequency device is an IC tag.

13. The image capturing apparatus according to claim 11, wherein
said image capturing apparatus and said predetermined reproducing apparatus are connected through a network, and
said access information contains an IP address in said network.

14. The image capturing apparatus according to claim 11, wherein
said image capturing apparatus and said predetermined reproducing apparatus are connected through a network, and
said access information contains authentication information for permitting said predetermined reproducing apparatus to make access to said image capturing apparatus through said network.

15. The image capturing apparatus according to claim 14, wherein
said authentication information contains at least one of a user ID and a password.

16. A reproducing apparatus comprising:
a receiver for receiving access information for permitting access to a predetermined image capturing apparatus stored in a radio frequency device provided in said predetermined image capturing apparatus;
an access controller for making access to said predetermined image capturing apparatus based on said access information received by said receiver; and
a reproducer for reproducing image data transmitted from said predetermined image capturing apparatus to which access has been made by said access controller.

17. The reproducing apparatus according to claim 16, wherein
said radio frequency device is an IC tag.

18. The reproducing apparatus according to claim 16, wherein
said predetermined image capturing apparatus and said reproducing apparatus are connected through a network, and
said access information contains an IP address in said network.

19. The reproducing apparatus according to claim 16, wherein
said predetermined image capturing apparatus and said reproducing apparatus are connected through a network, and
said access information contains authentication information for permitting access to said predetermined image capturing apparatus from said reproducing apparatus through said network.

20. The reproducing apparatus according to claim 19, wherein
said authentication information contains at least one of a user ID and a password.
